(19) United States
(12) Patent Application Publication
(10) Pub. No.: US 2022/0240527 A1
(43) Pub. Date: Aug. 4, 2022

(54) CONTROLLING RIPENING OF VEGETABLE PRODUCE IN A TRANSPORT UNIT

(71) Applicant: Maersk Container Industry A/S, Tinglev (DK)

(72) Inventors: Niels Nielsen POULSEN, Vojens (DK); Poul Kim MADSEN, Tinglev (DK); Alexandru LUCA, Odense C (DK)

(21) Appl. No.: 17/629,287

(22) PCT Filed: Apr. 17, 2020
(86) PCT No.: PCT/EP2020/060929

§ 371 Date: Jan. 21, 2022

(30) Foreign Application Priority Data
Jul. 22, 2019 (DK) PA 2019 70474

(51) Int. Cl. A23B 7/152

(52) U.S. Cl. CPC A23B 7/152; A23V 2002/00

(57) ABSTRACT

A method for controlling ripening of vegetable produce in a second transport unit is disclosed. The method comprises obtaining, at the second transport unit, ripening data from a first transport unit, which first transport unit carries produce from a same geographical area as the second transport unit; correlating, at the second transport unit, the obtained ripening data with a scheduled delivery date for the second transport unit; and controlling, at the second transport unit, a ripening process of the produce during transport based on the correlated data for achieving a desired ripening stage in the produce at the scheduled delivery date.

### CROSS-REFERENCE TO RELATED APPLICATIONS

This application is a 371 of International Application No. PCT/EP2020/060929, filed Apr. 17, 2020, which claims priority to Danish Application No. PA 2019 70474, filed Jul. 22, 2019 under 35 U.S.C. § 119(a). Each of the above-referenced patent applications is incorporated by reference in its entirety.

### BACKGROUND

### Field of the Invention

The present disclosure relates generally to the field of ripening of vegetable produce. More particularly, it relates to controlling ripening of vegetable produce in a transport unit.

### Description of the Related Technology

Ripenable produce are often transported overseas in ships and reefer containers. Keeping the ripenable produce at a temperature controlled atmosphere prevents ripening of the produce. Over shorter distances ripenable produce can be transported by a refrigerated truck or trailer.

In current approaches, when a shipment of ripenable produce has reached its destination, the ripenable produce must stored in a warehouse for a period of time to be ripened. After the ripenable produce have spent time in the ripening warehouse, the ripenable produce can be distributed to the marketplaces/distribution centres with acceptable ripeness.

A first drawback of current approaches for ripening of vegetable produce is that the ripenable produce must be stored in an intermediate storage for a period of time once reaching the destination and before distribution in order to reach an acceptable ripeness in the vegetable produce.

A second drawback of current approaches is that the period of time in the intermediate storage varies depending on the properties of the vegetable produce and is therefore difficult to plan for.

Therefore, there is a need for alternative approaches for ripening of vegetable produce.

### SUMMARY

It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an apparatus is referred to herein, it is to be understood as a physical product. The physical product may comprise one or more parts, such as controlling circuitry in the form of one or more controllers, one or more processors, or the like.

It is an object of some embodiments to solve or mitigate, alleviate, or eliminate at least some of the above or other drawbacks.

According to a first aspect, this is achieved by a method for controlling ripening of vegetable produce in a second transport unit.

The method comprises obtaining, at the second transport unit, ripening data from a first transport unit, which first transport unit carries produce from a same geographical area as the second transport unit; correlating, at the second transport unit, the obtained ripening data with a scheduled delivery date for the second transport unit; and controlling, at the second transport unit, a ripening process of the produce during transport based on the correlated data for achieving a desired ripening stage in the produce at the scheduled delivery date.

In some embodiments, the ripening data comprises ripening intensity data and/or ripening stage data.

In some embodiments, the ripening stage data comprises one or more parameters indicative of a ripening stage of the produce.

In some embodiments, the one or more parameters of the ripening stage data comprise one or more of accumulated CO2 production or accumulated O2 consumption per mass unit for the ripening process of a specific produce measured from time of injection of ripening agent to time of delivery; and assessed ripening stage when the first transport unit (1A) is delivered and opened by recipient.

In some embodiments, the ripening intensity data comprises one or more parameters indicative of an acceleration time of the ripening process.

In some embodiments, the one or more parameters of the ripening intensity data comprise one or more of a period from when a ripening agent is dosed into the container and until respiration rate reaches a pre-determined level; a period from when a ripening agent is dosed into the container until produce have reached a pre-determined accumulated respiration; and the respiration rate measured at a pre-determined time after ripening agent is dosed into the first container.

In some embodiments, the one or more parameters of the ripening intensity data comprise one or more of a period from when a ripening agent is dosed into the container and until respiration rate reaches a pre-determined level for respiration rate being in an interval between 3 to 20 ml/kg/hr, such as 15 ml/kg/hr produced CO2 or consumed 02; a period from when a ripening agent is dosed into the container (1A) until produce have reached a pre-determined accumulated respiration of 200 to 1000 ml CO2/kg or O2/kg, such as 450 to 550 more such as 500 ml CO2/kg; and the respiration rate measured in ml/kg/hr produced CO2 or consumed O2 at a pre-determined time being 75 to 250 hours, such as 100 to 140 hours, such as 120 hours after ripening agent is dosed into the first container.

In some embodiments, the method further comprises identifying, at the second transport unit, the first transport unit by obtaining an identifier, wherein the identifier is indicative of a transport unit carrying produce from the same geographical area as the second transport unit.

In some embodiments, the geographical area comprises one or more farms, wherein the one or more farms are identifiable based on Farm ID.

In some embodiments, the second transport unit comprises a temperature-controlled compartment and a first equipment for controlling a temperature in the temperature-controlled compartment.

In some embodiments, the second transport unit further comprises a second equipment for controlling an atmosphere within the second transport unit and/or within the temperature-controlled compartment of the second transport unit.

In some embodiments, the controlling of the ripening process comprises controlling, by the first equipment and/or the second equipment, one or more of ripening temperature, ripening agent dosing start-time, and oxygen concentration within the second transport unit and/or within the temperature-controlled compartment of the second transport unit.

In some embodiments, the correlating of the obtained ripening intensity data comprises correlating data comprising assessed ripening stage from at least one previous shipment of the transport unit, accumulated CO2 production or accumulated O2 consumption per mass unit to calculate a target accumulated CO2 production or accumulated O2 consumption per mass unit to achieve a target ripening stage of the produce in the second transport unit.

In some embodiments, the controlling of the ripening process comprises following ripening stage thresholds: if produce is too ripe, lowering one or more of the parameters: temperature, O2 level, CO2 level, quantity of dosage of ripening agent or time for start of dosing ripening agent in relation to time of transport until delivery; or if produce is too unripe, increasing one or more of the parameters: temperature, O2 level, CO2 level, quantity of dosage of ripening agent or time for start of dosing ripening agent in relation to time of transport until delivery.

In some embodiments, place of harvest is identifiable by the identifier and/or by coordinates from/by a localization-unit associated with the transport unit.

In some embodiments, the ripening data is transmitted from the first transport unit to the second transport unit before opening the first transport unit at delivery.

A second aspect is a computer program product comprising a non-transitory computer readable medium, having thereon a computer program comprising program instructions. The computer program is loadable into a data processing unit and configured to cause execution of the method according to the first aspect when the computer program is run by the data processing unit.

A third aspect is a transport unit for controlling ripening of vegetable produce.

The transport unit comprises a temperature-controlled compartment and a first equipment for controlling a temperature in the temperature-controlled compartment and a second equipment for controlling an atmosphere within the second transport unit and/or within the temperature-controlled compartment of the second transport unit, the second equipment further comprising a controller configured for controlling a composition of the atmosphere and further configured for controlling a ripening process of vegetable produce during transport of the transport unit, comprising a data storage operably connected to the controller and to a user interface for entering data indicative of an identifier identifying a first transport unit, the data storage operably connected to the user interface and/or a localization-unit for entering the data indicative of the identifier into the data storage and transmitting ripening data to a controller in a second transport unit identifiable by the identifier, carrying produce from a same geographical area identifiable by the identifier, and the data storage operably connected to a central computer for correlating the ripening data with a scheduled delivery date for the second transport unit and controlling the ripening process of the produce during transport based on the correlated data to achieve desired ripening stage in the produce at a scheduled delivery date.

In some embodiments, the transport unit further comprises one or more sensors operably connected to the controller and a ripening agent valve, the one or more sensors being configured to sense one or more of: temperature, O2, CO2, and ethylene (C2H4), and the controller being configured to compare sensed values from the one or more of the sensors with ripening data stored in data storage operably connected to the controller, the controller being further configured to calculate date and time for opening of ripening agent valve and activate opening of the valve at the calculated date and time.

In some embodiments, transport unit further comprises the one or more sensors being operably connected to the controller and the ripening agent valve, the one or more sensors being configured to sense one or more of: temperature, O2, CO2, and ethylene (C2H4), and the controller being configured to compare sensed values from the one or more of the sensors with ripening intensity data stored in the central computer and/or in a cloud, the controller being further configured to calculate date and time for opening of ripening agent valve and activate opening of the valve at the calculated date and time.

An advantage of some embodiments is that alternative approaches for ripening of vegetable produce are provided.

Yet an advantage of some embodiments is that a control of ripening of vegetable produce in a transport unit is enabled.

Yet an advantage of some embodiments is that the need for intermediate storage of vegetable produce for ripening purposes is removed.

Yet an advantage of some embodiments is that the ripening of vegetable produce is controlled based on the properties of the vegetable produce carried in the transport unit so that the complete ripening time for the vegetable produce carried in the transport unit corresponds to the time that the vegetable produce is in transport.

Yet an advantage of some embodiments is that the ripening of vegetable produce is controlled based on data obtained from other transport unit carrying vegetable produce with same or similar properties and there the ripening process during transport may generate predictable results.

Yet an advantage of some embodiments is that ripening of a variety of vegetable produce may be controlled in transport units as the properties of the vegetable produce carried in the transport unit provide a customized ripening process.

Yet an advantage of some embodiments is that an assessment of ripening of vegetable produce is performed by a human (i e a recipient of the transport unit) when opening the transport unit. The assessed ripening, i.e. assessment information which typically comprises know-how of the recipient, is fed back to the system so that other transport units carrying produce from the same geographical area may benefit from the assessment information.

Yet an advantage of some embodiments is that if the recipient assesses the vegetable produce as too ripened, the assessment information is fed back to the system so that acceleration time for ripening is reduced for other transport units comprising produce from the same geographical area and thereby receiving vegetable produce that are just ripened.

Yet an advantage of some embodiments is that if the recipient assesses the vegetable produce as not ripened enough, the assessment information is fed back to the system so that acceleration time for ripening is increased for other transport units comprising produce from the same geographical area and thereby receiving vegetable produce that are just ripened.

Any of the above aspects may additionally have features identical with or corresponding to any of the various features as explained above for any of the other aspects.

It should be noted that, even if embodiments are described herein in the context of ripening of vegetable produce, some embodiments may be equally applicable and/or beneficial also in other contexts.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a schematic drawing illustrating an example transport unit and equipment according to some embodiments;

FIG. 2 is a schematic drawing illustrating an example transport sequence according to some embodiments;

FIG. 3 is a plot illustrating an example change of activity for a produce according to some embodiments;

FIG. 4 is a plot illustrating an example change of activity for a produce according to some embodiments;

FIG. 5 is a plot illustrating an example relation according to some embodiments; and

FIG. 6 is a plot illustrating example relations according to some embodiments.

### DETAILED DESCRIPTION

As already mentioned above, it should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

As mentioned above, a first drawback of current approaches for ripening of vegetable produce is that the ripenable produce must be stored in an intermediate storage for a period of time once reaching the destination and before distribution in order to reach an acceptable ripeness in the vegetable produce.

Further, as mentioned above, a second drawback of current approaches is that the period of time in the intermediate storage varies depending on the properties of the vegetable produce and is therefore difficult to plan for.

In the following, embodiments will be presented where alternative approaches for ripening of vegetable produce are described.

A geographical area, as described herein, may typically comprise any one of a region, a country, and an area with a 100 km radius. The geographical area may be pre-determined or may be determined or adjusted during transport.

A delivery date, as described herein, may typically comprise a time to delivery. The time to delivery may comprise any one of a date, a date and a time, an interval of dates, and a date and interval of time.

A recipient, as described herein, may typically comprise a human opening the transport unit at delivery.

The method for controlling ripening of vegetable produce in a second transport unit 1B comprises the following steps.

In optional step 101, in some embodiments, a first transport unit 1A is identified at the second transport unit.

In optional step 101a, in some embodiments, an identifier 16 is obtained, wherein the identifier 16 is indicative of a first transport unit 1A carrying produce from the same geographical area as the second transport unit 1B.

The identifier, as described herein, may typically comprise a transport unit ID indicative of the identity of the transport unit and a Farm ID indicative of the geographical area of the one or more farms.

Alternatively or additionally, the obtaining of the identifier may be performed over wireless communication.

In step 102, ripening data from the first transport unit 1A is obtained at the second transport unit 1B, which first transport unit 1A carries produce from a same geographical area as the second transport unit 1B.

For example, the geographical area may comprise one or more farms, wherein one farm may be identified via a Farm ID for the specific farm or a plurality of farms, e.g. a cluster comprising adjacent farms, may be identified via a Farm ID for the plurality of farms.

Alternatively or additionally, the obtaining of the ripening data is performed over wireless communication.

In step 103, the obtained ripening data is correlated at the second transport unit 1B with a scheduled delivery date for the second transport unit 1B.

In step 104, a ripening process of the produce is controlled at the second transport unit 1B during transport based on the correlated data for achieving a desired ripening stage in the produce at the scheduled delivery date.

The transport unit for controlling ripening of vegetable produce comprises a temperature-controlled compartment 2 and a first equipment 2a for controlling a temperature in the temperature-controlled compartment 2, and a second equipment 3 for controlling an atmosphere within the transport unit and/or within the temperature-controlled compartment 2.

Alternatively or additionally, the first equipment 2a and the second equipment 3 may be integrated in a same equipment.

The second equipment 3 further comprises a controller 9 configured for controlling a composition of the atmosphere and further configured for controlling a ripening process of vegetable produce during transport of the transport unit.

The transport unit further comprises a data storage operably connected to the controller 9 and to a user interface 100 for entering data indicative of an identifier 16. The identifier 16 is for identifying a transport unit carrying produce from a same geographical area (i.e. transport unit 1A).

The data storage may be further operably connected to a central computer 14 for correlating the ripening data with a scheduled delivery date for the transport unit (i.e. transport unit 1B) and for controlling the ripening process of the produce during transport based on the correlated data to achieve desired ripening stage in the produce at a scheduled delivery date.

Alternatively or additionally, the ripening process is controlled based on the ripening data obtainable via the central computer 14 or a fixed protocol corresponding to transport information associated with the transport unit 1A,1B.

A central computer, as described herein, may typically comprise a computer in a system configured to receive ripening data from one or more transport unit, wherein the received ripening data is associated with an identifier of the transport unit which has provided the ripening data and/or the place of harvest and/or the harbor the transport unit has been dispatched from. The computer is further configured to provide ripening data based on a request identifying a transport unit/place of harvest/dispatching harbor.

The central computer, as described herein, may further comprise one or more instances of a central computer and/or a cloud server which may be scalable to receive and/or provide ripening data to one or more transport units during transport over wireless communication.

A fixed protocol, as described herein, may typically comprise information corresponding to a transport unit, wherein the information may comprise GPS data and/or data of place of harvest of the produce and/or the harbor the transport unit is departing from of which information may provide an identifier for obtaining data from the central computer.

In some embodiments, the transport unit further comprises a localization-unit 110.

For example, the localization-unit 110 may comprise a Global Positioning System (GPS) unit.

In some embodiments, the transport unit comprises controlling circuitry (e.g. controller 9) configured to transmit and/or receive ripening data.

In some embodiments, the transport unit is configured to upload ripening data to a central computer.

In some embodiments, the transport unit is configured to download ripening data from a central computer.

In some embodiments, the transport unit may be any one of a reefer container, a truck, and a trailer.

It should be noted that, even if embodiments are described herein in the context of ripening of vegetable produce, some embodiments may be equally applicable and/or beneficial also in other contexts wherein properties of produce in transport are to be controlled in a process over time.

The invention relates to a method of ripening vegetable produce in a transport unit being a reefer container, truck or trailer having a temperature controlled compartment and a temperature controlling machine comprising equipment for establishing controlled atmosphere within the temperature controlled compartment, the temperature controlling machine comprising a controller for controlling the composition of the atmosphere to an O2 content of 1-21% and a CO2 content of 0-20% of the atmosphere within the container and further controlling a ripening process during transport of the transport unit

The invention further relates to a transport unit being a reefer container, truck or trailer having a temperature controlled compartment and a temperature controlling machine comprising equipment for establishing controlled atmosphere within the temperature controlled compartment, the temperature controlling machine comprising a controller configured for controlling the composition of the atmosphere to an O2 content of 1-21% and a CO2 content of 0-20% of the atmosphere within the container and further configured for controlling a ripening process during transport of the transport unit.

Ripenable produce are often transported overseas in ships and reefer containers. Keeping the ripenable produce at a temperature controlled atmosphere prevents ripening of the produce. Over shorter distances ripenable produce can be transported by a refrigerated truck or trailer.

One example of a ripenable produce can be bananas. When a shipment of bananas has reached its destination, the bananas must be ripened in a warehouse for a period of time. After the bananas have spent time in the ripening warehouse, the bananas can be distributed to the marketplaces/distribution centres with acceptable ripeness.

To determine the ripening stage of the bananas a 7 stage classification of banana ripening can be used. Stage 1 is all green bananas, stage 2 is green with trace of yellow, stage 3 is more green than yellow, stage 4 is more yellow than green, stage 5 is yellow with green tips and necks, stage 6 is all yellow and stage 7 is all yellow with brown flecks. Previously the bananas would be received off the ship at stage 1—all green and following ripened in a ripening warehouse.

Another example of such a ripenable produce can be avocados, plums, melons or mangos.

For several produces a classification stage of ripening exist. For example a four stage classification is used for avocados and a five stage classification is used for mangos.

Further examples of ripenable produces can be fruits, vegetables. In fact most produce having a kind of respiration and which are adaptable for lowered respiration rate, can be transported in this way.

It is therefore advantageous if the ripening process can be controlled during shipment in such a way that the produce can be distributed to distribution centres or even to supermarkets in a ripened state i.e. ready to use upon sale to customers.

Different solutions exist in relation to containers in respect of controlled atmosphere and ripening produce, but common for these solutions are that they are not able to carefully control the ripening process in such a way that the produce arrives to the distributor or supermarket in a “close to be used” state. By a “close to be used” state is meant that the produce can be used/eaten just after purchasing or within a few days after purchasing.

A method and a transport unit according to the invention provides the capability of delivery of ripened produce in a predetermined or desired ripening state.

Equipment is developed for ripening of fruit or vegetables during transport with correction of ripening time based on harvest date, place of harvest and/or ongoing feedback from recipient or ripe fruit.

The ripening is carried out in a reefer container, truck or trailer for ripening of vegetable produce and is based on a predefined program in a micro controller configured for controlling temperature, humidity and composition of atmosphere within the temperature controlled compartment of the reefer container, truck or trailer. This is also called Controlled Atmosphere or (CA).

A source containing and configured for releasing ripening agent to the temperature controlled compartment is mounted to the transport unit and releasing/injection of ripening agent to the temperature controlled compartment is controlled by the micro controller.

A ripening period starting when ripening agent is released/injected into the temperature controlled compartment, and thereby mixed with the gasses or atmosphere surrounding the produce to be ripened, and until the produce is ripened, depend on parameters such as composition of gas/atmosphere, temperature, and growth conditions for the produce in the field during growth until harvest.

These parameters are controlled manually in ripening rooms as used today and a common way to determine when the produce is sufficiently ripened is to use colour and/or hardness of the produce.

In order to be able to perform this control of ripening state, it is necessary for a person to enter the ripening room and pick out some samples of the produce on basis of which a ripening rate is determined. This can also be necessary because the ripening room can be filled with different types of produces and different batches having different states of ripening.

When transporting ripenable produce in a reefer container loaded on a ship, it is not very easy or possible at all, to get access to the container. Further it is insuperable to access and check the number of containers having the same cargo and loaded on a ship.

Even if the container is loaded on a truck or on a train, it is not expedient to open the container because the controlled atmosphere (CA) obtained within the container will then be spoiled and the ripening process can, due to the opening of the container, be unnecessarily prolonged or shortened compared to the ripening state expected on arrival/delivery.

The problem to be solved is to improve a method of ripening produce during transport in a container and at the same time ensure that the ripeness of the produce is as close as possible, and preferable corresponding to the ripeness ordered by recipient of the produce.

One challenge of being able to obtain a preordered ripeness stage at delivery is that speed of ripening of one load of produce in one container can vary in relation to a load in another container even though the produce is same type, for example bananas. Different sorts of bananas can have different sensitivity in relation to one or more of O2, CO2 and ripening agent resulting in different ripening speed.

This is solved by a method of ripening vegetable produce in a transport unit being a reefer container, truck or trailer having a temperature controlled compartment and a temperature controlling machine comprising equipment for establishing controlled atmosphere within the temperature controlled compartment, the temperature controlling machine comprising a controller for controlling the composition of the atmosphere to an O2 content of 1-21% and a CO2 content of 0-20% of the atmosphere within the container and further controlling a ripening sequence during transport of the transport unit, the method comprising following steps:

Identifying a first ripening container by transport ID or Farm ID and transferring ripening intensity data from the first container to a second ripening container identified by transport ID or Farm ID, carrying same produce from same farm or adjacent farm, ripening intensity data being one or more of the following:

a. defined as a period from ripening agent is dosed into the container and until respiration rate reaches a set level for respiration rate being in an interval including 3 to 20 ml/kg/hr, such as 12 to 18 ml/kg/hr, such as 15 ml/kg/hr produced CO2 or consumed 02;
b. defined as a period from ripening agent is dosed into the container until produce have reached an accumulated respiration of 200 to 1000 ml CO2/kg, such as 450 to 550 ml CO2/kg, such as 500 ml CO2/kg;
c. Defined as a respiration rate measured in ml CO2/kg produce/hr at a time being 75 to 250 hours, such as 100 to 140 hours, such as 120 hours after ripening agent is dosed into the container;

Correlate the ripening intensity data with scheduled delivery date for the second container to time the ripening process by changing ripening temperature, ripening agent dosing start-time or oxygen concentration to achieve desired ripening stage at scheduled delivery.

According to an embodiment the method further comprises transferring following data obtained from the first identified ripening container to the second identified ripening container carrying same produce from same farm or adjacent farm:

accumulated CO2 production or accumulated O2 consumption per mass unit for the ripening process of a specific produce measured from time of injection of ripening agent to time of delivery; and

assessed ripening stage when the first container is delivered and opened by recipient.

According to an embodiment, the method further comprises using correlation between achieved/assessed ripening stage from previous shipments having same Farm ID, accumulated CO2 production or accumulated O2 consumption per mass unit to calculate a target accumulated CO2 production or accumulated O2 consumption per mass unit correlated to target ripening stage of the produce in the second ripening container.

According to an embodiment, the method further comprises controlling of the ripening process by changing ripening temperature, ripening agent dosing start-time or O2 concentration to achieve calculated target accumulated CO2 or O2 consumption per mass unit during the ripening process.

According to an embodiment, the parameters are adjusted based on a feed-back linked to the transport ID and sent to the central computer, which feed-back is received from recipient and rates the ripeness of the produce in relation to desired ripeness comprising the steps of:

If ripeness is acceptable—do not adjust parameters;

If produce is too ripe—adjust by lowering one or more of the parameters: temperature, O2 level, CO2 level, quantity of dosage of ripening agent or time for start of dosing ripening agent in relation to time of transport until delivery;

If produce is too unripe—adjust by increasing one or more of the parameters: temperature, O2 level, CO2 level, quantity of dosage of ripening agent and/or time for start of dosing ripening agent in relation to time of transport until delivery.

It is only possible to start the ripening process earlier in case the ripening has not started yet. Therefore if the ripening has started at the time of feed-back from an already delivered container, and the ripening process has to be slowed down, one or more of the parameters: temperature, O2 level, CO2 level, quantity of dosage of ripening agent must be lowered.

The ripening process cannot be stopped once initiated, but removing any ripening agent from the atmosphere within the temperature controlled compartment, lowering the temperature, lowering the O2 level and/or lowering the CO2 level can be tools to slow down the ripening process.

According to an embodiment, place of harvest is identified by entered Farm ID or automatically entered coordinate from/by a GPS-unit placed in or on the container.

Farm ID and/or transport ID can be entered via a user interface operably connected to a data storage in the controller or linked to a cloud storage. The controller and/or cloud storage capable of being in communication with a central computer.

The user interface can be a touch screen, a key pad, a keyboard or similar.

The user interface can also be in communication with a mobile computer, laptop, smartphone, tablet or a desktop computer, transferring data to the controller and/or cloud storage.

According to an embodiment, feed-back is sent to the central computer via a mobile computer, laptop, smartphone, tablet or a desktop computer.

According to an embodiment, ripening intensity data are transmitted from the first ripening container to the second ripening container before delivery of the first ripening container.

According to an embodiment, data from adjacent farms are used if data from actual farm is missing or deviates from previous data from same farm with more than ±5%.

In case data relating to a Farm ID is missing, an alternative method can be used. Many reasons can result in a missing Farm ID. For example the farm can have interrupted deliverance to the shipping company due to change of client or the farm could be struck by incidents causing the farm to be unable to deliver produces for a period and after a while takes up delivery.

Since the data gathered from earlier transports are dependent on conditions changing over relatively short periods being days or weeks, a data gap of more than two weeks can result in a load being delivered at an unwanted ripeness/ripening rate.

In such a situation, data from an adjacent or neighbouring farm can be used or data from farms in vicinity of the farm not able to deliver newly gathered data according to the above.

In order to handle ripenable produce according to the methods mentioned above, a transport unit being a reefer container, truck or trailer having a temperature controlled compartment and a temperature controlling machine comprising equipment for establishing controlled atmosphere within the temperature controlled compartment, the temperature controlling machine comprising a controller configured for controlling the composition of the atmosphere to an O2 content of 1-21% and a CO2 content of 0-20% of the atmosphere within the transport unit and further configured for controlling a ripening process during transport of the transport unit, comprising:

A data storage operably connected to the controller and to a user interface for entering data identifying a first ripening container by transport ID, the data storage operably connected to the user interface and/or a GPS-unit for entering Farm ID into the data storage and transferring ripening intensity data to a second ripening container identified by transport ID or Farm ID, carrying same produce from same farm or adjacent farm, and

The data storage operably connected to a central computer for correlating the ripening intensity data with scheduled delivery date for the second container timing the ripening process by changing ripening temperature, ripening agent dosing start-time or oxygen concentration, achieving desired ripening stage at scheduled delivery.

In an embodiment, the transport unit further comprises one or more sensors operably connected to the controller and a ripening agent valve, the one or more sensors sensing at least one of following parameters: temperature, O2, CO2 or ethylene (C2H4) and compares sensed values from one or more of the sensors with ripening intensity data stored in the controller, the controller calculating date and time for opening of ripening agent valve and activates opening of the valve at the calculated date and time.

In an alternative embodiment, the transport unit further comprises one or more sensors operably connected to the controller and a ripening agent valve, the one or more sensors sensing at least one of following parameters: temperature, O2,CO2 or ethylene (C2H4) and compares sensed values from one or more of the sensors with ripening intensity data stored in the central computer or in a cloud, the controller calculating date and time for opening of ripening agent valve and activates opening of the valve at the calculated date and time.

The above and other features and advantages of the present invention will become readily apparent to those skilled in the art by the following detailed description of exemplary embodiments thereof with reference to the attached drawings, in which:

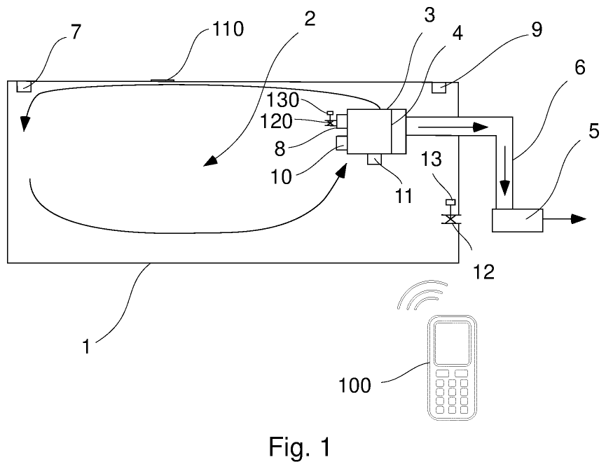

FIG. 1 shows a transport unit in shape of a reefer container for shipping perishable products such as fruit and vegetables comprising equipment for establishing and maintaining a controlled atmosphere within the container;

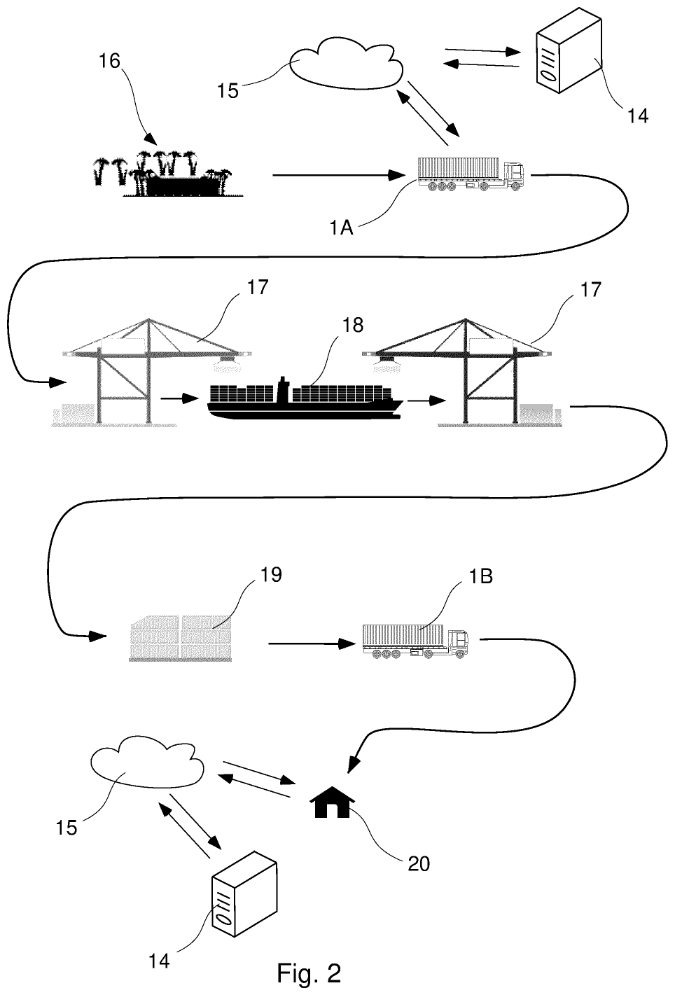

FIG. 2 shows schematically a transport sequence of a produce, here as an example bananas;

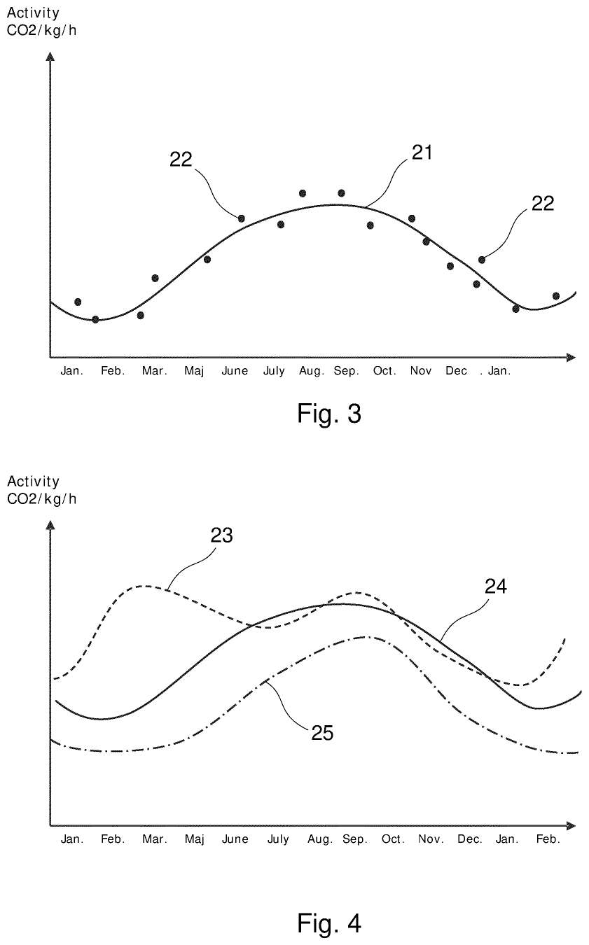

FIG. 3 shows a curve illustrating a yearly change of activity (CO2 production) for a produce (here bananas) for a specific farm, based on feed-back from one or more costumers;

FIG. 4 show curves illustrating a yearly change of activity (CO2 production) for a produce (here bananas) from three different farms/areas;

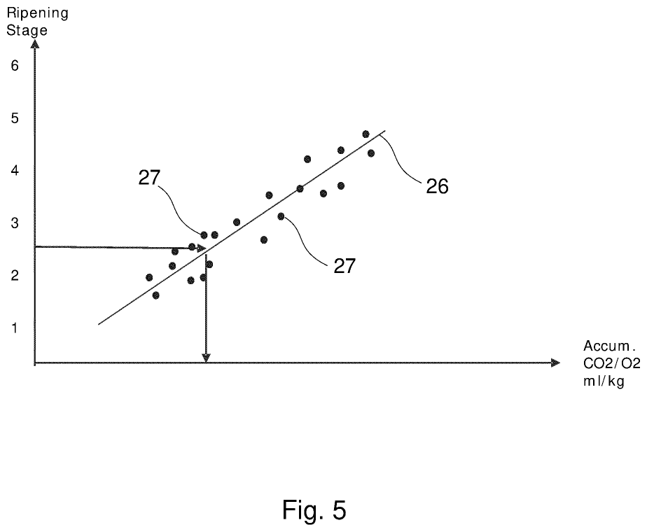

FIG. 5 shows an example of an average relation between ripening stage of a produce and accumulated CO2 production or O2 consumption, based on feed-back from one or more costumers; and

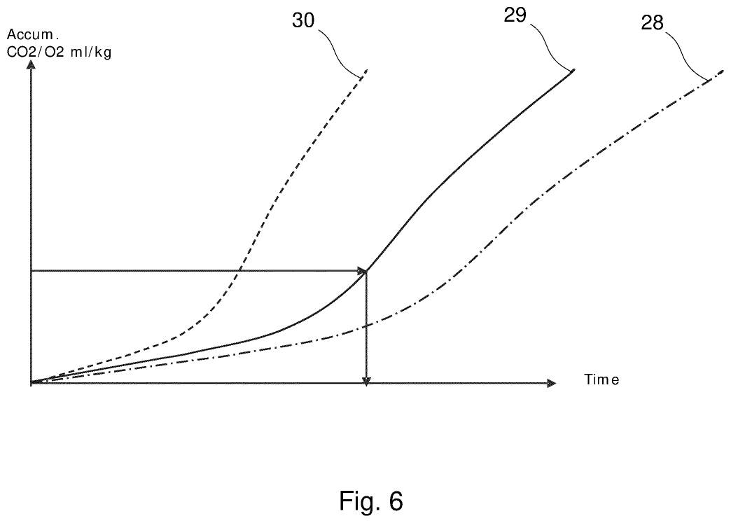

FIG. 6 shows relation between time and accumulated CO2 production or O2 consumption for three different activity levels of produce (low, normal and high activity levels).

Various embodiments are described hereinafter with reference to the figures. Like reference numerals refer to like elements throughout. Like elements will, thus, not be described in detail with respect to the description of each figure.

It should also be noted that the figures are only intended to facilitate the description of the embodiments.

They are not intended as an exhaustive description of the claimed invention or as a limitation on the scope of the claimed invention. In addition, an illustrated embodiment needs not have all the aspects or advantages shown.

An aspect or an advantage described in conjunction with a particular embodiment is not necessarily limited to that embodiment and can be practiced in any other embodiments even if not so illustrated, or if not so explicitly described.

Throughout, the same reference numerals are used for identical or corresponding parts.

Ripenable produce are transported in a transport unit 1 being a reefer container, truck or trailer having a temperature controlled cargo compartment 2 and a temperature controlling machine (not shown) comprising equipment for establishing controlled atmosphere 3 within the temperature controlled compartment 2, the temperature controlling machine comprising a controller 9 for controlling the composition of the atmosphere to an O2 content of 1-21% and a CO2 content of 0-20% of the atmosphere within the container and further controlling a ripening process during transport of the transport unit 1.

When ripening produce begins to produce CO2, the controlled atmosphere system 3 by means of a pressure swing absorber or a membrane 4 can adjust the CO2 content within the temperature controlled compartment or load space 2 of the container 1.

The controlled atmosphere system 3 can be provided with a pipe 6 to a valve or a vacuum pump 5.

In case the controlled atmosphere system 3 is provided with a vacuum pump 5, CO2 will be removed through the membrane 4 via the pipe 6 and the pump 5 to the surroundings.

When gas is removed from the inside of the container it will be replaced by ambient atmospheric air entering through natural gaps or slots in the container 1, e.g. around the doors thereof or through a valve 12, which valve is operated by a valve control unit 13 controlled by the controller 9.

Measuring CO2 concentration within the container 1 is carried out by a CO2 sensor 7.

The controlled atmosphere system 3 includes sensors 7 capable of measuring at least one of following parameters: temperature, O2 or CO2. In an embodiment the controlled atmosphere system 3 includes a sensor unit 7 capable of measuring following parameters: temperature, O2 or CO2.

The controlled atmosphere system 3 also includes a dosing mechanism for dosing ripening agent 8, and the controller 9, which controller besides controlling the controlled atmosphere system also controls the ripening process based on sensed values of temperature, O2 and/or CO2.

In an embodiment, the controlled atmosphere system 3 comprises a dosing mechanism 10 for a ripening agent receptor blocking agent.

An example of such a ripening agent receptor blocking agent can be 1-MCP.

According to one embodiment, the controlled atmosphere system comprises a ripening agent removal system 11 comprising photo-catalytic destruction, destruction by ozone or absorption removal.

According to one embodiment, the ripening agent is ethylene and/or propylene and/or acetylene.

When starting a transport, different parameters are registered in a central computer 14. The registration takes place via a communication line or wireless communication and data can be transferred directly to the central computer 14 or to the central computer 14 via a cloud storage 15. The data can be processed in the central computer, based on data retrieved from computer memory, from cloud storage or from both. The parameters can be transport ID (identification of the specific transport), type of produce to be transported, scheduled time of delivery and wanted ripeness at delivery. These parameters can be provided by the shipping company. Further parameters such as product information, time of harvest, packaging time (can be provided by a time registration unit in the controller), place of harvest (can be determined by GPS equipment 110 placed in or on the container) are entered or read off to/by the controller of the temperature controlling machine. The central computer 14 receives Information from the container, truck or trailer 1 regarding product type, time of scheduled delivery and wanted ripening rate, time and place of loading, when the parameters are entered in, or available in the controller 9. These parameters are compared to data from earlier experience.

At the time when the cargo room 2 of the container, truck or trailer 1 is opened at arrival, the cargo is inspected for rate of ripening and quality by a supervisor and a result from the evaluation/inspection is entered to a register in the central computer 14 together with the transport ID.

The evaluation feed-back of the inspection is communicated to the central computer 14 via a mobile computer, laptop, smartphone, tablet or a desktop computer (not shown).

Evaluation feed-back from receiver of the cargo is registered in the central computer 14 and is associated to the parameters already entered into the central computer 14, the parameters being one or more of the parameters transport ID, produce (type and variety), place of harvest (Farm ID) 16, time of harvest and actual ripening data.

In an embodiment, the evaluation feed-back from receiver of the cargo is registered in the central computer 14 and is associated to the parameters already entered into the central computer 14, the parameters being at least three of the parameters transport ID, produce (type and variety), place of harvest (Farm ID) 16, time of harvest and actual ripening data.

As an alternative or a supplement to the evaluation feed-back, also weather data can be collected/received from locally placed weather stations or weather data collectors, or data from official weather services can be collected and entered into measuring of the ripening period or ripening time.

The central computer 14 carries out the data processing of incoming data for calculation of ripening time of the fruit (type and variety) with relation to time of harvest and place or location of farm 16, from where the produce is harvested (Farm ID).

The central computer 14 calculates expected ripening rate on future and ongoing transports. This calculation is based, for example on time of harvest.

As an example can be mentioned that bananas harvested in winter periods do not react on increased ripening conditions as fast as bananas harvested in the summer period.

To compensate, it can be necessary to start the ripening process earlier during the transport, raise the temperature or inject excess ripening agent, to achieve a sufficient ripened produce at arrival.

By continuously comparing new data with earlier experienced data, an experience database is build up and form a calculating model, making it possible to carry out a best guess on a produce's ripening behaviour.

As an example a load of bananas is scheduled to arrive three weeks from loading into containers 1. When loading the batch of bananas, data regarding type of banana, identification of farm 16 growing the bananas, transport ID for identification of the specific transport, scheduled time of delivery and rate of ripeness is sent to a central computer 14, which computer communicates with a controller 9 in shape of a micro controller controlling the temperature controlling machine (not shown) of the reefer container 1.

The ripening process is controlled, based on a wanted ripeness at arrival/delivery, and the bananas are at a start kept in controlled atmosphere (CA), maintaining a steady atmosphere and temperature state where there is no ripening, which is for bananas normally in a range between 13.5-14.5° C.

At normal conditions, the ripening process is initiated ten days before scheduled delivery by modifying the controlled atmosphere and/or dosing or injecting a ripening agent and raising the temperature to be in a range of 14.5-18° C.

When the bananas arrives to the supermarket 20, the state of ripening is checked and if the state of ripening is not as wished, a feed-back is sent, for example by an app on a smartphone or by a computer to the central computer 14, which central computer 14 is in communication with the micro controller 9 of the temperature controlling machine in the container 1.

In an embodiment the micro controller, which is in communication with the central computer 14, can be a separate controller, controlling the O2 and CO2 content as well as controlling a valve 120 for injection of ripening agent into the load space 2 of the container 1. The ripening agent valve 120 is operated by a valve control unit 130 controlled by the controller 9.

The communication can take place via a communication line or wireless communication and data can be transferred directly to the central computer 14 or to the central computer 14 via a cloud storage 15. The data can be processed in the central computer, based on data retrieved from computer memory, from cloud storage or from both.

Each container 1 is identified and linked to a transport ID so the central computer 14 is able to communicate with specific containers 1 carrying a specific load.

When feed-back is sent from the receiver 20 of the load, the central computer 14 receives data showing the ripening state of the load or cargo. If the ripening state is as wished, data is communicated from the central computer 14 to the micro controller 9 of the specific containers 1 used in relation to the specific transports to this costumer, that nothing should be changed in relation to the ripening process during the transport unless changes in the scheduled shipment occurs.

In case of later or earlier arrival than scheduled, the ripening rate is adjusted to achieve the wanted ripeness at delivery.

The invention is related to a method of ripening vegetable produce in a transport unit being a reefer container, truck or trailer 1 having a temperature controlled compartment 2 and a temperature controlling machine comprising equipment 3 for establishing controlled atmosphere within the temperature controlled compartment 2, the temperature controlling machine comprising a controller 9 for controlling the composition of the atmosphere to an O2 content of 1-21% and a CO2 content of 0-20% of the atmosphere within the transport unit 1 and further controlling a ripening process during transport of the transport unit 1, the method comprising following steps:

Identifying a first ripening container 1A by transport ID or Farm ID 16 and transferring ripening intensity data from the first container 1A to a second ripening container 1B identified by transport ID or Farm ID 16, carrying same produce from same farm 16 or adjacent farm, ripening intensity data being one or more of the following:

a. defined as a period from ripening agent is dosed into the container 1 and until respiration rate reaches a set level for respiration rate being in an interval between 3 to 20 ml/kg/hr, such as 15 ml/kg/hr produced CO2 or consumed 02;
b. defined as a period in time from ripening agent is dosed into the container 1 until produce have reached an accumulated respiration of 200 to 1000 ml CO2/kg, such as 450 to 550 more such as 500 ml CO2/kg;
c. defined as a respiration rate measured in ml CO2/kg produce/hr at a time being 75 to 250 hours, such as 100 to 140 hours, such as 120 hours after ripening agent is dosed into the container 1;

Correlate the ripening intensity data with scheduled delivery date for the second container 1B to time the ripening process by changing ripening temperature, ripening agent dosing start-time or oxygen concentration to achieve desired ripening stage at scheduled delivery.

According to one embodiment, the method further comprises transferring following data obtained from the first identified ripening container 1A to the second identified ripening container 1B carrying same produce from same farm 16 or adjacent farm:

accumulated CO2 production or accumulated O2 consumption per mass unit for the ripening process of a specific produce measured from time of injection of ripening agent to time of delivery; and

assessed ripening stage when container 1A is delivered and opened by recipient.

According to one embodiment, the method further comprises using correlation between achieved/assessed ripening stage from previous shipments having same Farm ID 16, accumulated CO2 production or accumulated O2 consumption per mass unit to calculate a target accumulated CO2 production or accumulated O2 consumption per mass unit correlated to target ripening stage of the produce in the second ripening container 1B.

According to one embodiment, the method further comprises controlling of the ripening process by changing ripening temperature, ripening agent dosing start-time or O2 concentration to achieve calculated target accumulated CO2 or O2 consumption per mass unit during the ripening process.

According to one embodiment of the method, the parameters are adjusted based on a feed-back linked to the transport ID and sent to the central computer 14, which feed-back is received from recipient and rates the ripeness of the produce in relation to desired ripeness comprising the steps of:

If ripeness is acceptable—do not adjust parameters;

If produce is too ripe—adjust by lowering one or more of the parameters: temperature, O2 level, CO2 level, quantity of dosage of ripening agent or time for start of dosing ripening agent in relation to time of transport until delivery;

If produce is too unripe—adjust by increasing one or more of the parameters: temperature, O2 level, CO2 level, quantity of dosage of ripening agent or time for start of dosing ripening agent in relation to time of transport until delivery.

According to one embodiment of the method, place of harvest is identified by entered Farm ID 16 or automatically entered coordinate from/by a GPS-unit 110 placed in or on the container 1.

Farm ID and/or transport ID can be entered via a user interface 100 operably connected to a data storage in the controller 9 or linked to a cloud storage 15. The controller 9 and/or cloud storage 15 capable of being in communication with a central computer 14.

The user interface 100 can be a touch screen, a key pad, a keyboard or similar. The user interface 100 can also be in communication with a mobile computer, laptop, smartphone, tablet or a desktop computer, transferring data to the controller 9 and/or cloud storage 15.

According to one embodiment of the method, feed-back is sent to the central computer 16 via a mobile computer, laptop, smartphone, tablet or a desktop computer.

According to one embodiment of the method, ripening intensity data are transmitted from the first ripening container 1A to the second ripening container 1B before opening of container 1A at delivery.

According to one embodiment of the method, data from adjacent farms are used if data from actual farm 16 is missing or deviates from previous data from same farm 16 with more than ±5%.

In order to handle ripenable produce according to the methods mentioned above a transport unit 1 for shipping perishable products such as fruit and vegetables is provided. The transport unit being a reefer container, truck or trailer 1 having a temperature controlled compartment 2 and a temperature controlling machine comprising equipment 3 for establishing controlled atmosphere within the temperature controlled compartment 2, the temperature controlling machine comprising a controller 9 configured for controlling the composition of the atmosphere to an O2 content of 1-21% and a CO2 content of 0-20% of the atmosphere within the transport unit 1 and further configured for controlling a ripening process during transport of the transport unit 1, comprising:

A data storage operably connected to the controller 9 and to a user interface 100 for entering data identifying a first ripening container 1A by transport ID, the data storage operably connected to the controller 9 and to the user interface 100 and/or a GPS-unit 110 for entering Farm ID 16 into the data storage and transferring ripening intensity data to a second ripening container 1B identified by transport ID or Farm ID 16, carrying same produce from same farm 16 or adjacent farm, and

The data storage operably connected to a central computer 14 for correlating the ripening intensity data with scheduled delivery date for the second container 1B timing the ripening process by changing ripening temperature, ripening agent dosing start-time or oxygen concentration, achieving desired ripening stage at scheduled delivery.

According to one embodiment, the transport unit further comprises one or more sensors 7 operably connected to the controller 9 and a ripening agent valve 120, the one or more sensors 7 sensing at least one of following parameters: temperature, O2, CO2 or ethylene (C2H4) and compares sensed values from one or more of the sensors 7 with ripening intensity data stored in the controller 9, the controller calculating date and time for opening of ripening agent valve 120 and activates opening of the valve 120 at the calculated date and time.

According to an alternative embodiment, the transport unit further comprises one or more sensors 7 operably connected to the controller 9 and a ripening agent valve 120, the one or more sensors 7 sensing at least one of following parameters: temperature, O2, CO2 or ethylene (C2H4) and compares sensed values from one or more of the sensors 7 with ripening intensity data stored in the central computer 14 or in a cloud 15, the controller calculating date and time for opening of ripening agent valve 120 and activates opening of the valve 120 at the calculated date and time.

In an embodiment, the ripening agent is injected from a container or bottle 8, which content is injected into the cargo space 2 of the container 1 when the controller 9 activates a ripening agent valve 120. The valve 120 can be a valve capable of opening and closing fluid communication between the ripening agent container/bottle 8 and the load space 2 of the temperature controlled container 1 or the valve 120 can be a type which is not intended to be closed when opened.

When ripening agent is injected into the cargo space 2 of the temperature controlled container 1, the CA system will close off fluid communication with the ambient atmosphere until a specified raise in CO2 production or O2 consumption is achieved.

FIG. 3 illustrates a yearly change of activity (CO2 production) for a produce (here bananas) for a specific farm 16, based on feed-back from one or more costumers. A solid line 21 represents a yearly change in average activity (CO2 production) for a produce from a specific farm 16 or area, and dots 22 represents calculated activity based on feed-back from one or more costumers. The dots 22 representing different feed-backs show a distribution close to the average activity 21 changing over a year.

FIG. 4 illustrates a yearly change of activity (CO2 production) for a produce (here bananas) from three different farms 16/areas, farm/area 23, farm/area 24 and farm/area 25. It is clear that data from all three farms 16/areas have a sort of peak around September/October, but the curve also shows a difference between farms 24, 25 and farm 23 in relation to activity (CO2 production). For example that produce from farm 23 has a peak showing higher activity (CO2 production) also in February/March.

FIG. 5 illustrates an average relation between ripening stage of a produce and accumulated CO2 production or O2 consumption, based on feed-back from one or more costumers. A solid line 26 represents the average relation between ripening stage (here the ripening stage scale for bananas is used as an example) and dots 27 represents the relation between ripening stage of the produce and accumulated CO2 production or O2 consumption of the produce, based on feed-back from one or more costumers.

FIG. 6 illustrates relation between time and accumulated CO2 production or O2 consumption for three different activity levels of produce (low 28, normal 29 and high 30 activity levels). The line 29 representing normal activity reflects the desired ripening stage of a produce.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

### LIST OF EMBODIMENTS

A. Method of ripening vegetable produce in a transport unit being a reefer container, truck or trailer (1) having a temperature controlled compartment (2) and a temperature controlling machine comprising equipment (3) for establishing controlled atmosphere within the temperature controlled compartment (2), the temperature controlling machine comprising a controller (9) for controlling the composition of the atmosphere to an O2 content of 1-21% and a CO2 content of 0-20% of the atmosphere within the transport unit (1) and further controlling a ripening process during transport of the transport unit (1), the method comprising following steps:
a. Identifying a first ripening container (1A) by transport ID or Farm ID (16) and transferring ripening intensity data from the first container (1A) to a second ripening container (1B) identified by transport ID or Farm ID (16), carrying same produce from same farm (16) or adjacent farm, ripening intensity data being one or more of the following:
   i. defined as a period from ripening agent is dosed into the container (1) and until respiration rate reaches a set level for respiration rate being in an interval between 3 to 20 ml/kg/hr, such as 15 ml/kg/hr produced CO2 or consumed 02;
   ii. defined as a period in time from ripening agent is dosed into the container (1) until produce have reached an accumulated respiration of 200 to 1000 ml CO2/kg, such as 450 to 550 more such as 500 ml CO2/kg;
   iii. defined as a respiration rate measured in ml CO2/kg produce/hr at a time being 75 to 250 hours, such as 100 to 140 hours, such as 120 hours after ripening agent is dosed into the container (1);
b. Correlate the ripening intensity data with scheduled delivery date for the second container (1B) to time the ripening process by changing ripening temperature, ripening agent dosing start-time or oxygen concentration to achieve desired ripening stage at scheduled delivery.

B. Method according to embodiment A, the method further comprises transferring following data obtained from the first identified ripening container (1A) to the second identified ripening container (1B) carrying same produce from same farm (16) or adjacent farm:
a. accumulated CO2 production or accumulated O2 consumption per mass unit for the ripening process of a specific produce measured from time of injection of ripening agent to time of delivery; and
b. assessed ripening stage when container (1A) is delivered and opened by recipient.

C. Method according to embodiment A or B, the method further comprises using correlation between achieved/assessed ripening stage from previous shipments having same Farm ID (16), accumulated CO2 production or accumulated O2 consumption per mass unit to calculate a target accumulated CO2 production or accumulated O2 consumption per mass unit correlated to target ripening stage of the produce in the second ripening container (1B).

D. Method according to embodiment A, B or C, the method further comprises controlling of the ripening process by changing ripening temperature, ripening agent dosing start-time or O2 concentration to achieve calculated target accumulated CO2 or O2 consumption per mass unit during the ripening process.

E. Method according to one or more of the embodiments of A-D, wherein the parameters are adjusted based on a feed-back linked to the transport ID and sent to the central computer (14), which feed-back is received from recipient and rates the ripeness of the produce in relation to desired ripeness comprising the steps of:
a. If ripeness is acceptable—do not adjust parameters;
b. If produce is too ripe—adjust by lowering one or more of the parameters: temperature, O2 level, CO2 level, quantity of dosage of ripening agent or time for start of dosing ripening agent in relation to time of transport until delivery;
c. If produce is too unripe—adjust by increasing one or more of the parameters: temperature, O2 level, CO2 level, quantity of dosage of ripening agent or time for start of dosing ripening agent in relation to time of transport until delivery.

F. Method according to one or more of the embodiments of A-E, wherein place of harvest is identified by entered Farm ID (16) or automatically entered coordinate from/by a GPS-unit (110) placed in or on the container (1).

G. Method according to one or more of the embodiments of A-F, wherein feed-back is sent to the central computer (16) via a mobile computer, laptop, smartphone, tablet or a desktop computer.

H. Method according to embodiment A or B, wherein ripening intensity data are transmitted from the first ripening container (1A) to the second ripening container (1B) before opening of container (1A) at delivery.

I. Method according to one or more of the embodiments A-H, wherein data from adjacent farms are used if data from actual farm (16) is missing or deviates from previous data from same farm (16) with more than ±5%.

J. A transport unit being a reefer container, truck or trailer (1) having a temperature controlled compartment (2) and a temperature controlling machine comprising equipment (3) for establishing controlled atmosphere within the temperature controlled compartment (2), the temperature controlling machine comprising a controller (9) configured for controlling the composition of the atmosphere to an O2 content of 1-21% and a CO2 content of 0-20% of the atmosphere within the transport unit (1) and further configured for controlling a ripening process during transport of the transport unit (1), comprising:
a. A data storage operably connected to the controller (9) and to a user interface (100) for entering data identifying a first ripening container (1A) by transport ID, the data storage operably connected to the user interface (199) and/or a GPS-unit (110) for entering Farm ID (16) into the data storage and transferring ripening intensity data to a controller (9) in a second ripening container (1B) identified by transport ID or Farm ID (16), carrying same produce from same farm (16) or adjacent farm, and
b. The data storage operably connected to a central computer (14) for correlating the ripening intensity data with scheduled delivery date for the second container (1B) timing the ripening process by changing ripening temperature, ripening agent dosing start-time or oxygen concentration, achieving desired ripening stage at scheduled delivery.

K. A transport unit according to embodiment J, further comprising one or more sensors (7) operably connected to the controller (9) and a ripening agent valve (120), the one or more sensors (7) sensing at least one of following parameters: temperature, O2, CO2 or ethylene (C2H4) and compares sensed values from one or more of the sensors (7) with ripening intensity data stored in the controller (9), the controller calculating date and time for opening of ripening agent valve (120) and activates opening of the valve (120) at the calculated date and time.

L. A transport unit according to embodiment J, further comprising one or more sensors (7) operably connected to the controller (9) and a ripening agent valve (120), the one or more sensors (7) sensing at least one of following parameters: temperature, O2,CO2 or ethylene (C2H4) and compares sensed values from one or more of the sensors (7) with ripening intensity data stored in the central computer (14) or in a cloud (15), the controller calculating date and time for opening of ripening agent valve (120) and activates opening of the valve (120) at the calculated date and time.

What is claimed is:

1. A method for controlling ripening of vegetable produce in a second transport unit, the method comprising the steps of:
obtaining, at the second transport unit, ripening data from a first transport unit, which first transport unit, carries produce from a same geographical area as the second transport unit,
correlating, at the second transport unit, the obtained ripening data with a scheduled delivery date for the second transport unit, and
controlling, at the second transport unit, a ripening process of the produce during transport based on the correlated data for achieving a desired ripening stage in the produce at the scheduled delivery date.

2. The method according to claim 1, wherein the ripening data comprises at at least one of ripening intensity data and ripening stage data.

3. The method according to claim 2, wherein the ripening stage data comprises one or more parameters indicative of a ripening stage of the produce.

4. The method according to claim 3, wherein the one or more parameters of the ripening stage data comprise one or more of:
accumulated CO2 production or accumulated O2 consumption per mass unit for the ripening process of a specific produce measured from time of injection of ripening agent to time of delivery; and
assessed ripening stage when the first transport unit is delivered and opened by recipient.

5. The method according to claim 2, wherein the ripening intensity data comprises one or more parameters indicative of an acceleration time of the ripening process.

6. The method according to claim 5, wherein the one or more parameters of the ripening intensity data comprise one or more of:
a period from when a ripening agent is dosed into the container and until respiration rate reaches a pre-determined level;
a period from when a ripening agent is dosed into the container until produce have reached a pre-determined accumulated respiration; and
the respiration rate measured at a pre-determined time after ripening agent is dosed into the first container.

7. The method according to claim 6, wherein the one or more parameters of the ripening intensity data comprise one or more of:
a period from when a ripening agent is dosed into the container and until respiration rate reaches a pre-determined level for respiration rate being in an interval between 3 to 20 ml/kg/hr, such as 15 ml/kg/hr produced CO2 or consumed O2;
a period from when a ripening agent is dosed into the container until produce have reached a pre-determined accumulated respiration of 200 to 1000 ml CO2/kg or O2/kg, such as 450 to 550 more such as 500 ml CO2/kg; and
the respiration rate measured in ml/kg/hr produced CO2 or consumed O2 at a pre-determined time being 75 to 250 hours, such as 100 to 140 hours, such as 120 hours after ripening agent is dosed into the first container.

8. The method according to claim 1, wherein the method further comprises:
identifying, at the second transport unit, the first transport unit by obtaining an identifier, wherein the identifier is indicative of a transport unit carrying produce from the same geographical area as the second transport unit.

9. The method according to claim 8, wherein the geographical area comprises one or more farms, wherein the one or more farms are identifiable based on Farm ID.

10. The method according to claim 1, wherein the second transport unit comprises a temperature-controlled compartment and a first equipment for controlling a temperature in the temperature-controlled compartment.

11. The method according to claim 10, wherein the second transport unit further comprises a second equipment for controlling an atmosphere within at least one of the second transport unit and the temperature-controlled compartment of the second transport unit.

12. The method according to claim 11, wherein the controlling of the ripening process comprises controlling, by at least one of the first equipment and the second equipment, one or more of: ripening temperature, ripening agent dosing start-time, oxygen concentration within the second transport unit, and oxygen concentration within the temperature-controlled compartment of the second transport unit.

13. The method according to claim 1, wherein the correlating of the obtained ripening intensity data comprises correlating data comprising assessed ripening stage from at least one previous shipment of the transport unit, accumulated CO2 production or accumulated O2 consumption per mass unit to calculate a target accumulated CO2 production or accumulated O2 consumption per mass unit to achieve a target ripening stage of the produce in the second transport unit.

14. The method according to claim 1, wherein the controlling of the ripening process comprises following ripening stage thresholds:
If produce is too ripe, lowering one or more of the parameters: temperature, O2 level, CO2 level, quantity of dosage of ripening agent, and time for start of dosing ripening agent in relation to time of transport until delivery; or
If produce is too unripe, increasing one or more of the parameters: temperature, O2 level, CO2 level, quantity of dosage of ripening agent, and time for start of dosing ripening agent in relation to time of transport until delivery.

15. The method according to claim 1, wherein place of harvest is identifiable by at least one of the identifier and coordinates from/by a localization-unit associated with the transport unit.

16. The method according to claim 1, wherein the ripening data is transmitted from the first transport unit to the second transport unit before opening the first transport unit at delivery.

17. A computer program product comprising a non-transitory computer readable medium, having thereon a computer program comprising program instructions, the computer program being loadable into a data processing unit and configured to cause execution of the method according to claim 1 when the computer program is run by the data processing unit.

18. A transport unit comprising a temperature-controlled compartment and a first equipment for controlling a temperature in the temperature-controlled compartment and a second equipment for controlling an atmosphere within at least one of the second transport unit and the temperature-controlled compartment of the second transport unit, the second equipment further comprising a controller configured for controlling a composition of the atmosphere and further configured for controlling a ripening process of vegetable produce during transport of the transport unit, comprising:
a data storage operably connected to the controller and to a user interface for entering data indicative of an identifier identifying a first transport unit, the data storage operably connected to at least one of the user interface and a localization-unit for entering the data indicative of the identifier into the data storage and transmitting ripening data to a controller in a second transport unit identifiable by the identifier, carrying produce from a same geographical area identifiable by the identifier, and
the data storage operably connected to a central computer for correlating the ripening data with a scheduled delivery date for the second transport unit and controlling the ripening process of the produce during transport based on the correlated data to achieve desired ripening stage in the produce at a scheduled delivery date.

19. The transport unit according to claim 18, further comprising one or more sensors operably connected to the controller and a ripening agent valve, the one or more sensors being configured to sense one or more of: temperature, O2, CO2, and ethylene, and the controller being configured to compare sensed values from the one or more of the sensors with ripening data stored in data storage operably connected to the controller, the controller being further configured to calculate date and time for opening of ripening agent valve and activate opening of the valve at the calculated date and time.

20. The transport unit according to claim 18, further comprising one or more sensors operably connected to the controller and the ripening agent valve, the one or more sensors being configured to sense one or more of: temperature, O2, CO2, and ethylene, and the controller being configured to compare sensed values from the one or more of the sensors with ripening intensity data stored in at least one of the central computer and a cloud, the controller being further configured to calculate date and time for opening of ripening agent valve and activate opening of the valve at the calculated date and time.
